(19) United States
(12) Patent Application Publication
(10) Pub. No.: US 2008/0309050 A1
(43) Pub. Date: Dec. 18, 2008

(54) HEIGHT ADJUSTABLE MOTORCYCLE TRAINING WHEELS

(76) Inventor: Greg McIntyre, Wellington, KS (US)

Correspondence Address: CORNELIUS P. DUKELOW;ABINGTON INTELLECTUAL PROPERTY LAW GROUP, PC, 10026-A S, MINGO ROAD, NO. 240, TULSA, OK, 74133, US

(21) Appl. No.: 11/764,780

(22) Filed: Jun. 18, 2007

(51) Int. Cl. B60B 37/10; B60B 35/00; B62H 7/00

(52) U.S. Cl. 280/293; 301/125; 301/127

(57) ABSTRACT

A height adjustable motorcycle training wheel apparatus including a base plate that is detachably attachable to the underside of a motorcycle engine case or frame. A detachably attachable axle is attached to the base plate and a pair of auxiliary wheels are rotatably maintained thereon. The axle includes a series of bends that create a secondary axle axis that is parallel to and offset from the primary axle axis. The distance between the auxiliary wheels and the riding surface may be adjusted by detaching the axle from the base plate, rotating the axle to the desired position, and reattaching the axle to the base plate.

### BACKGROUND OF THE INVENTION

1. Field of the Invention

The present invention relates generally to stabilizing devices for motorcycles. More particularly, the present invention relates to height adjustable motorcycle training wheels.

2. Description of Related Art

Motorcycles are commonly used by families and individuals of all ages for entertainment and recreation purposes. In fact, most major motorcycle manufactures around the world produce small motorcycles for the enjoyment of young riders as well as adults. Learning to ride a motorcycle, however, takes time and practice. Motorcycles include various controls that add to the difficulty of learning to ride, i.e., throttle, clutch, hand break, foot break, shifter, etc. One of the major impediments to mastering the various controls and learning to balance a motorcycle is the fear of tipping, and learners, especially children, benefit when the danger of tipping is reduced.

Thus, a need exists for a practical apparatus for use with motorcycles that reduces the risk of tipping while novice motorcycle riders learn to operate controls and balance themselves simultaneously. A need also exists for such an apparatus to be height adjustable so that it may be used by individuals with varying degrees of motorcycle riding proficiency and on motorcycles of various heights and sizes.

### BRIEF SUMMARY OF THE INVENTION

It is the primary object of the present invention to present a height adjustable motorcycle training wheel apparatus for use on motorcycles operated by inexperienced riders in an effort to prevent tipping of the motorcycle during operation. It is another object of the present invention to present a height adjustable motorcycle training wheel apparatus that is simple in design, manufacture, and use.

The present invention accomplishes the above-mentioned and other objects and overcomes disadvantages associated with other motorcycle training wheels by providing a base plate that is detachably attachable to the underside of a motorcycle engine case or frame, an axle, a pair of auxiliary wheels, a means for detachably attaching the base plate to the underside of a motorcycle engine case or frame, a means for detachably attaching the axle to the base plate, and a means for rotatably maintaining the auxiliary wheels on the axle.

### BRIEF DESCRIPTION OF THE SEVERAL VIEWS OF THE DRAWING

FIG. 1 illustrates a perspective view of the base plate with attached cable clamps and the bent axle and a cross section of one auxiliary wheel attached to the axle.

FIG. 2 illustrates a perspective view of the base plate with attached cable clamps.

FIG. 3 illustrates an additional view of the base plate with attached cable clamps.

While the disclosure is susceptible to various modifications and alternate constructions, certain illustrative examples thereof have been shown in the drawings and will be described below in detail. It should be understood, however, that there is no intention to limit the disclosure to the specific forms disclosed, but on the contrary, the intention is to cover all modifications, alternate constructions, and the equivalents falling within the spirit and scope of the invention as defined by the claims.

### DETAILED DESCRIPTION OF THE INVENTION

The embodiments discussed herein are merely illustrative of specific manners in which to make and use the invention and are not to be interpreted as limiting the scope of the instant invention.

While the invention has been described with a certain degree of particularity, it is to be noted that modifications may be made in the details of the invention's construction and the arrangement of its components without departing from the spirit and scope of this disclosure. It is understood that the invention is not limited to the embodiments set forth herein for the purposes of exemplification.

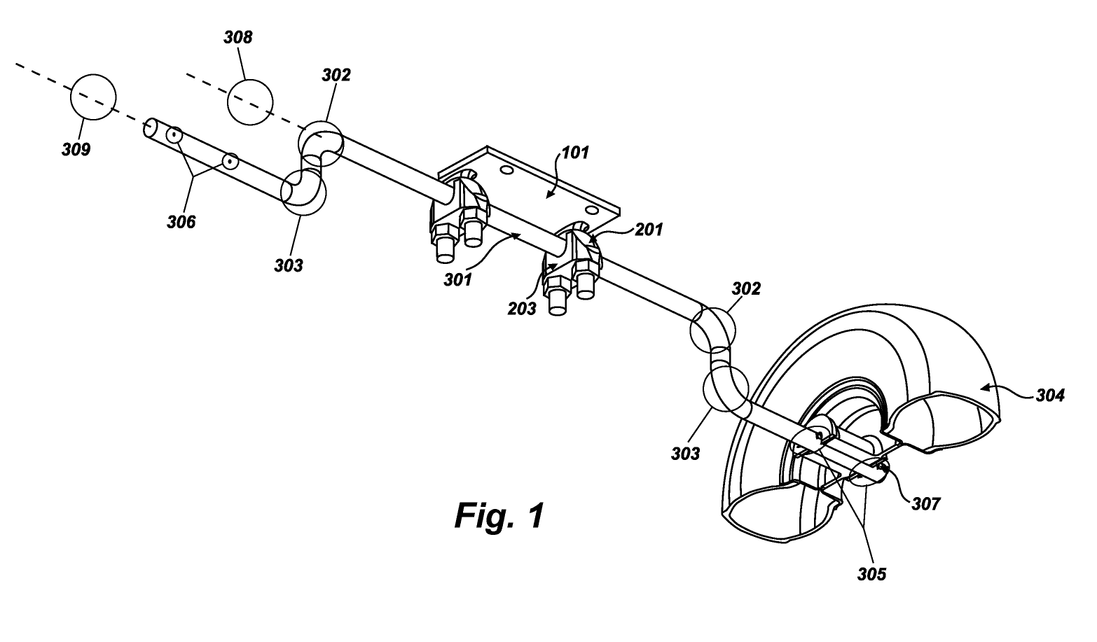

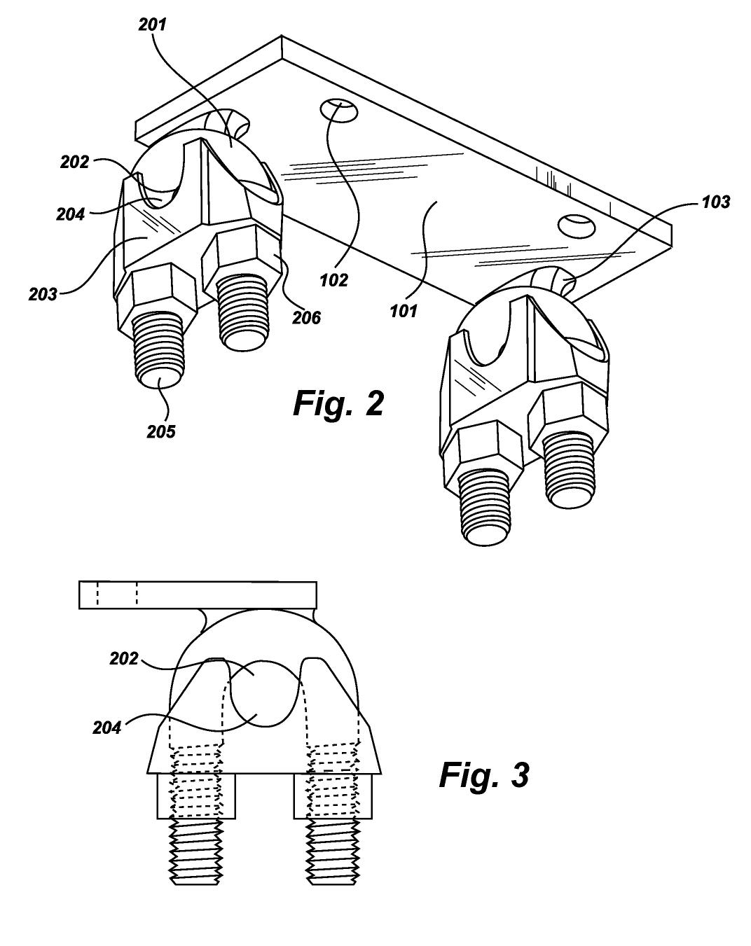

FIGS. 1 through 3 show a height adjustable training wheel apparatus for use on motorcycles constructed in accordance with the present invention.

The present invention includes a base plate 101 that is detachably attachable to the underside of a motorcycle engine case or frame. In the present embodiment, the base plate 101 is detachably attached to the underside of a motorcycle engine case or frame by aligning a plurality of pre-positioned base plate bolt holes 102 located on the base plate 101 with a plurality of corresponding bolt holes located on the engine case or frame and bolting the base plate to the engine case or frame. Other means for detachably attaching the base plate to the underside of a motorcycle engine case or frame include a plurality of clamps, pins, locking levers, adhesives, bonding agents, etc.

Fixed to the base plate 101 is a means for detachably attaching an axle 301 to the base plate 101. In the present embodiment, the means for detachably attaching the axle 301 to the base plate 101 is a pair of cable clamps permanently affixed, by welding or other suitable means 103, to the base plate 101 on the side of the base plate opposite that which contacts the motorcycle engine case or frame. Other means for detachably attaching an axle 301 to the base plate 101 include using U-bolts.

Each cable clamp is comprised of a cable clamp holder 201 having a cable clamp holder concavity 202, a cable clamp cover piece 203 having a cable clamp cover piece concavity 204 for closing the cable clamp holder concavity 202, and a means for detachably attaching, and locking the cable clamp cover piece 203 to the cable clamp holder 201. In the present embodiment, the means for detachably attaching, and locking each cable clamp cover piece to each cable clamp holder is a pair of nuts 206 that tighten onto the cable clamp bolts 205. In alternate embodiments, the means for detachably attaching, and locking each cable clamp cover piece to each cable clamp holder could include locking levers, wing nuts, split pins, etc. The axle 301 is detachably attached by positioning it into the cable clamp holder concavity 202, mating the cable clamp cover piece 203 to the cable clamp holder 201 and fixing the axle 301 and cable clamp cover piece 203 into place by tightening a pair of nuts 206 onto the cable clamp bolts 205.

The axle 301 contains a series of at least four axle bends 302 & 303. The first pair of bends 302 are made on the same axial plane at points equidistant from the center of the axle (as measured on the longitudinal axis of the axle) and mirror each other in angle and direction. The second pair of bends 303 are made on the same axial plane as the first set of bends at points equidistant from the center of the axle (as measured on the longitudinal axis of the axle) at points outside the first set of bends. The second pair of bends are identical in angle, but are made in opposite directions. The second pair of bends establish an offset secondary axle axis 309 that is parallel to the primary axle axis 308. The distance between the primary axle axis 308 and secondary axle axis 309 (offset) may be manipulated by the adjusting the angle of the bends and/or the distance between the bends.

A pair of auxiliary wheels 304 are rotatably supported on the ends of the axle 301 and held into place by impediment members 305. In the present embodiment, the means for maintaining the auxiliary wheels on the axle are a set of axle holes 306 and corresponding pins 307 locked into the axle holes 306, with the auxiliary wheel located there between. In alternate embodiments, the means for maintaining a auxiliary wheel on the axle could include creating or permanently fixing a stopping member (a protuberance or washer for example) along the axle, sliding the auxiliary wheel onto the axle and against the stopping member, and maintaining the auxiliary wheel on the axle by securing a nut or cover member on the end of the axle. The height of the auxiliary wheels 304 may be adjusted by detaching the cable clamp cover piece 203 from the cable clamp holder 201, rotating the axle 301 to the desired position, and reattaching the cable clamp cover piece 203 to the cable clamp holder 201.

Whereas, the present invention has been described in relation to the drawings attached hereto, it should be understood that other and further modifications, apart from those shown or suggested herein, may be made within the spirit and scope of this invention.

The invention claimed is:

1. A training wheels apparatus comprising:
a base plate;
an unbent axle with a primary axle axis;
a pair of auxiliary wheels;
means for detachably attaching said base plate to the underside of a motorcycle engine case or frame;
means for detachably attaching said axle to said base plate; and
means for rotatably maintaining said auxiliary wheels on said axle.

2. A training wheels apparatus as recited in claim 1, wherein:
said axle has a series of at least four bends so that a secondary axle axis is created that is parallel to and offset from the primary axle axis.

3. A training wheels apparatus as recited in claim 2, wherein:
said axle has a first pair of bends, made on the same axial plane at points equidistant from the center of the axle, that mirror each other in angle and direction; and
said axle has a second pair of bends, made on the same axial plane as said first set of bends at points equidistant from the center of the axle and at points outside said first pair of bends, that mirror each other in angle but are made in opposite directions.
